(19) United States
(12) Patent Application Publication
(10) Pub. No.: US 2002/0182128 A1
(43) Pub. Date: Dec. 5, 2002

(54) Devices and methods for performing an analyzing simultaneous chemical reactions

(76) Inventors: James Claude Carnahan, Niskayuna, NY (US); James Lawrence Spivack, Cobleskill, NY (US); Linda Leigh McCracken, Schenectady, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/681,779

(22) Filed: Jun. 4, 2001

(51) Int. Cl. G05D 23/00; B01J 8/00; G01N 31/10

(52) U.S. Cl. 422/188; 422/109; 422/197; 422/110

(57) ABSTRACT

The present invention includes an array of flow-through, temperature-controlled reactor tubes containing reagents or catalysts that are prepared using combinatorial techniques. Reactant gases are passed through the reactor tubes at a controlled rate and the effluent reaction products are collected for analysis using a variety of analytical techniques. Analysis may be done in real-time, or at a later time.

### BACKGROUND OF INVENTION

The present invention relates generally to methods and apparatus for simultaneous chemical reactions and analysis. More specifically, the present invention is directed to methods and apparatus for carrying out simultaneous chemical reactions and for analyzing their effluent products to evaluate the performance of multiple catalysts and reagents.

Chemical reactions such as gas-condensed phase reactions are studied to identify and measure the products of various reactions. These reactions involve at least one condensed phase catalyst reacting with at least one gaseous reagent, or at least one condensed phase reagent reacting with at least one gaseous catalyst, to convert one of the materials into some other species. A condensed phase material means that the material is either a liquid, a solid, or a solid suspended in a liquid. The catalysts, reagents and conditions of these reactions are evaluated to determine if potentially useful combinations have been discovered.

Traditionally, gas-condensed phase reactions have been investigated in pressure vessels, autoclaves, or single, tubular, flow-through reactors, with the reaction products being collected and analyzed off-line after a period of stable operation. Due to operational set-up requirements and operational time limitations associated with the traditional methods and devices, typically only a few reactions can be completed within a given work day. These methods were sufficient in the past, when the condensed phase catalysts or reagents used to have to be generated one combination at a time. However, catalysts and reagents can now be prepared using combinatorial synthesis techniques, which can quickly provide large numbers of test materials in small quantities. These combinatorially synthesized materials require fast, parallel reaction and analysis capabilities though.

What is needed are methods and apparatus for conducting multiple simultaneous gas-condensed phase reactions. What is also needed are methods and apparatus for conducting multiple simultaneous gas-condensed phase reactions that will not require a lot of work in between sets of reactions for connecting, disconnecting and getting ready for the next set of reactions. What is further needed is an apparatus for conducting multiple simultaneous gas-condensed phase reactions, that has minimal infrastructure (i.e., temperature controls, temperature measurements, gas flows, gas feeds, gas feed flow controls, etc.). What is still further needed are methods and apparatus for conducting multiple simultaneous gas-condensed phase reactions, using one common reaction set and one common gas feed stream that can react with multiple condensed phase materials in multiple reactor tubes. What is yet further needed are methods and apparatus for analyzing the reaction products of multiple simultaneous gas-condensed phase reactions. Finally, what is needed are methods and apparatus for real-time analysis of the reaction products of multiple simultaneous gas-condensed phase reactions.

### SUMMARY OF INVENTION

Accordingly, the above identified shortcomings are overcome by the present invention, which relates to methods and apparatus for simultaneous chemical reactions and analysis. The present invention discloses an apparatus and methods for carrying out simultaneous gas-condensed phase reactions with facilities for analyzing the effluent products of those reactions, thereby allowing catalyst and reagent performance to be much more quickly evaluated than in the past.

The present invention includes a system for supplying a controlled flow of gaseous reagents to an array of temperature-controlled reaction tubes that contain at least one reagent material within, and then collecting the effluent reaction products for real-time analysis or for analysis at a later time. In one embodiment, the system for performing simultaneous reactions in a plurality of flow-through reaction tubes includes a temperature control system operative to maintain a predetermined temperature in each of the plurality of flow-through reaction tubes. Additionally, the system includes a gas delivery system operative to deliver at a predetermined rate a reaction gas having a uniform composition to each of the plurality of flow-through reaction tubes, where the reaction gas is operative to react with a catalyst disposed within each of the plurality of flow-through reaction tubes to form a reaction product. Further, the system includes a collection device coupled to at least one of the plurality of flow-through reaction tubes for collecting the reaction product. Additionally, this system may allow for analyzing, in real-time if desired, the reaction products of the multiple, simultaneous reactions.

In another embodiment, a method for performing simultaneous reactions in a plurality of flow-through reaction tubes, comprises maintaining a predetermined temperature in each of the plurality of flow-through reaction tubes, delivering at a predetermined rate a reaction gas having a uniform composition to each of the plurality of flow-through reaction tubes, where the reaction gas is operative to react with a catalyst disposed within each of the plurality of flow-through reaction tubes to form a reaction product, and collecting the reaction product.

Further aspects and advantages of the present invention will be more clearly apparent to those skilled in the art during the course of the following description, references being made to the accompanying drawings which illustrate some preferred forms of the present invention and wherein like characters of reference designate like parts throughout the drawings.

### BRIEF DESCRIPTION OF DRAWINGS

FIG. 1 is a functional block diagram of one embodiment of a reaction system of the present invention;

FIG. 2 is a schematic top view of one embodiment of a thermal block of the present invention;

FIG. 3 is a schematic cross-sectional side view of the thermal block depicted in FIG. 2;

FIG. 4 is a schematic side cross-sectional view of one embodiment of a flow-through reaction tube of the present invention;

FIG. 5 is a schematic side cross-sectional view of another embodiment of a flow-through reaction tube with an internal center tube for delivering another reactant;

FIG. 6 is a functional block diagram of another embodiment of a reaction system of the present invention;

FIG. 7 is a schematic cross-sectional side view of a vaporizer module of the reaction system of FIG. 6;

FIG. 8 is a schematic cross-sectional side view of one of a plurality of reaction tubes having a spring-loaded inlet fitting mounted in a wall of the vaporizer module of FIG. 7; and

FIG. 9 is a schematic cross-sectional side view of one of the plurality of reaction tubes of FIG. 7 having an exit fitting mounted in a wall of a collection device.

### DETAILED DESCRIPTION

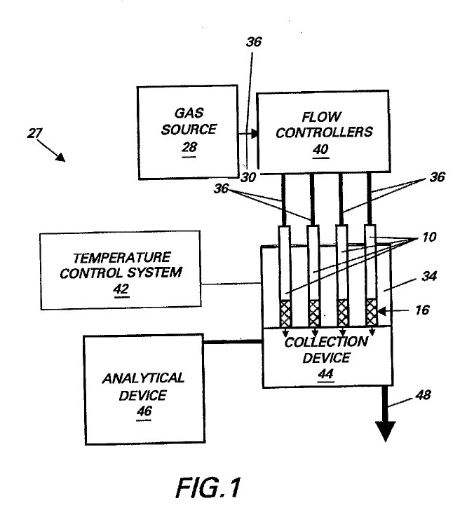

For the purposes of promoting an understanding of the principles of the invention, references will now be made to some of the preferred embodiments of the present invention as illustrated in FIGS. 1-9, and specific language used to describe the same. It will nevertheless be understood that no limitation of the scope of the invention is thereby intended. The terminology used herein is for the purpose of description and not limitation. Any modifications or variations in the depicted method or device, and such further applications of the principles of the invention as illustrated therein, as would normally occur to one skilled in the art, are considered to be within the spirit of this invention. For instance, features illustrated or described as part of one embodiment can be used on another embodiment to yield a still further embodiment. Thus, it is intended that the present invention cover such modifications and variations as come within the scope of the appended claims and their equivalents.

Referring now to FIG. 1, there is shown a block diagram of one embodiment of a reaction system 27 for simultaneously performing and analyzing an array of gas condensed phase reactions. A reactant gas source 28 for delivering a reactant gas 30 is operatively connected to a plurality of reaction tubes 10 via reactant gas delivery lines 36. Gas flow controllers 40 control the rate of flow of reactant gas 30 to each of the reaction tubes 10, which are substantially disposed within thermal block 34. Temperature control system 42 controls the temperature of thermal block 34 so that the temperature of the reactions within the reaction tubes 10 are sufficient to provide heating and/or cooling based on the desired reaction. Reactant gas 30 passes through each reaction tube 10 and reacts with one of a plurality of condensed phase catalysts or reagent beds 16 contained within the tube to produce one of a plurality of reaction products 32. The reaction products 32 from each separate reaction are then collected in collection device 44. One or more analytical devices 46 may be connected to collection device 44 so that reaction products 32 may be analyzed in real-time. Alternatively, reaction products 32 can be collected in collection device 44 and stored for analysis at a later time. Excess reaction products can then exit the system through vent 48.

The reaction system 27 allows for the testing and analysis of catalysts and reagents prepared using combinatorial syntheses. The combinatorial aspects of the system include providing for a different reaction to simultaneously occur in each reaction tube 10 based on tube-to-tube variations in one or more of the reactant gas 30, the reaction temperature, and the reactants including the condensed phase catalyst or reagent bed 16. The system 27 provides a common reactant gas 30 to each of the plurality of tubes and performs the plurality of different reactions in parallel, or in other words simultaneously, within the reaction tubes 10. Thus, the reaction system 27 provides large numbers of test materials or reaction products 32 in small quantities in a relatively short period of time when compared with traditional gas condensed phase reaction systems.

The reaction system 27 may be used to rapidly evaluate catalysts, reagents and conditions for reactions. These reactions include, but are not limited to, the reaction of: methanol and phenol on a catalyst bed to produce cresol or 2,6-xylenol; the reaction of methyl chloride with variously modified silicon metals to produce chlorosilanes; the reaction of methyl group-containing materials with silica or modified silica to produce alkyl and alkoxy silanes; the catalytic oxidation of aromatics, including benzene on catalysts to produce phenols; the synthesis of diphenyl carbonate and/or dimethyl carbonate; reactions involving the synthesis of silicones from organic compounds and silicon element-containing minerals; and the oxidation of ortho-dialkylated aromatics on catalysts to form anhydrides.

Reactant gas 30 may be supplied to the reaction tubes 10 in many ways, such as gas in pressurized tanks, as gas in headspace over low boiling liquids, as vapors produced by passing a gas stream through a liquid, as vapors produced by heating materials that are liquids at room temperature to above their boiling point and transferring the resulting vapor in heated lines, or by feeding liquids at a controlled rate to a vaporization chamber held above the boiling point of the liquid and connected to reactor tubes 10. There may also be more than one reactant gas 30 in the composition supplied to each reaction tube 10. Reactant gas 30 includes a material in the gaseous phase at a temperature and pressure within the system 27 or within the reaction tube 10, where the reactant gas interacts with the catalyst or reagent bed 16 to create a reaction that produces one or more reaction products 32. For example, reactant gas 30 may include a material or mixture of materials that is in gaseous form at room temperature, or reactant gas 30 may include a material or mix of materials that can be heated to form a vapor at a temperature below the decomposition temperature of the material(s) entrained in a flowing stream of a material or mix of materials that is a gas at the operating temperature for the reaction. For example, dimethylcarbonate can be entrained in an inert gas stream such as argon or helium and the resulting mixture can be used as a reacting vapor, with the dimethylcarbonate being the intended reagent. Another example includes benzene in a mixture of gases, at least one of which is an oxidizing gas, where both the benzene and the oxidizing gas(es) are reagents. Further, other suitable reactant gases 30 may be utilized depending on the desired reaction.

Condensed phase catalyst or reagent bed 16 includes a material or combination of materials that react at a given temperature and pressure with the supplied reactant gas 36 to form one or more reaction products 32. Condensed phase catalyst or reagent bed 16 includes materials in solid, liquid or gaseous phases, but preferably include one or more layers of catalysts or condensed phase reactant layers. For example, reagent 16 may include a solid catalyst or a liquid catalyst held on a solid. The type of reagent 16 may vary depending on the desired reaction.

The combination of reactant gas 36, condensed phase catalyst or reagent 16, temperature in the reaction tube 10 of the reactants, and pressure in the reaction tube, among other factors, may varying depending on the desired reaction and the desired reaction products.

Reaction tubes 10 can be disposable or reusable and are removable from thermal block 34. Reaction tubes 10 are preferably made of stainless steel, but can be made of any other suitable metal, glass, ceramic, or other inert material or a material that can be coated or plated on its interior surface to provide an inert environment for the gas-condensed phase reaction.

Gas flow controllers 40 include active flow controllers and/or passive flow controllers. Active flow controllers include devices such as pressure regulators, simple rotometers and mass flow controllers. Passive flow controllers include devices such as critical orifices, capillaries, fritted restrictors, needle valves, sintered plugs, small orifices, and capillary restrictors. Critical orifice flow controllers are preferred. In the case of reactant gases 30 that will condense at room temperature, gas flow controllers 40 and reactant gas delivery lines 36 may be temperature controlled. In order to obtain meaningful comparisons of activity in the various reaction tubes 10, the flow rate of the gaseous reactant(s) are preferably controlled to provide similar gas flow rates through each reaction tube 10, although the flow rate between tubes may be varied. Suitable flow control devices normalize the flow of gaseous reactants to the array of reaction tubes 10, independent of individual back-pressure in the reaction tubes 10. It should be noted that the operation of any flow controller to produce equivalent flows through the reactor tubes requires that the head pressure in the manifold be above any pressure drop in any of the tubes. Critical orifices require a somewhat higher head pressure so that they operate independently of downstream backpressure.

Collection device 44 may include devices for retrieving gaseous, liquid and solid forms, or combinations thereof, of one or more reaction products 32 from each reaction tube 10. Collection device 44 may simultaneously retrieve the reaction products 32 from each reaction tube 10, or the collection device may selectively retrieve the reaction product from a given reaction tube at a predetermined time period. For example, for a reaction product 32 in a gaseous or liquid form, a tube positioned adjacent the exit of the reaction products from the reaction tube that draws in the gas or liquid may be utilized as a collection device 44. Other suitable collection devices 44 include: using absorbent traps to trap effluent vapors for later desorption into an analytical device 46, using cryotraps to freeze and collect effluent vapors for later analysis, or using solvent traps to dissolve and hold the effluent vapors for later analysis. The use of solvent traps was found to be efficacious, especially when cooled to a temperature just above the freezing point of the highest melting point component of the expected effluent mixture. The preferred method of collecting reaction products 32 for later analysis is to condense the gaseous reaction products 32 into individual cooled receivers, such as vials filled with a trapping solvent. Further, the collection device 44 may vary depending upon the analytical device 46 utilized to test the reaction products 32.

Analytical device 46 includes any device or method for testing or inspecting the reaction products 32 for a desired characteristic. For example, suitable analytical devices 46 include spectroscopic, chromatographic, electrochemical or sensor-based devices. These devices may include devices that measure and/or analyze mass spectrometry, infrared absorbance, UV absorbance, fluorescence emission and gas chromatography. In situations where the elemental analysis of reaction products 32 is of interest, reaction products 32 may be monitored by element specific detectors such as flame photometric, chemiluminescent nitrogen, phosphorus or sulfur detectors or inductively coupled plasma (ICP) and ICP-mass spectrometry. For example, a device with fast analytical capability includes a mass spectrometer interfaced to sampling device 74 through a pressure drop device such as an open split interface, a jet separator or a membrane interface. The mass spectrometer signal may be referenced to the particular reaction tube 10 being sampled to provide rapid sequential analysis of reaction products 32. Further, integration, or in other words analysis over time, of the reaction products 32 may in some circumstances be beneficial to understand the net performance of a catalyst or reaction condition over a period of time or to understand the lifetime performance of a catalyst. The reaction products 32 may be collected from the system for later analysis by analytical device 46, or the analytical device may be directly connected to the system for performing real-time analysis.

Real-time analysis of reaction products 32 may be performed by using stream select valves and stream switching valves to direct one exit stream at a time to a fast analytical device 46, while maintaining the flow through the remaining reaction tubes 10. Commercially available valves, such as part #EMT4SD16MWE from VICI, can handle stream selection up to 16 streams, and combining multiples of these valves with lower multiplicity stream select valves would permit sampling the reaction tubes 10 in multiples of 16. Thus, for example, sampling of the reaction products 32 may be performed utilizing such valving in combination with analysis via a gas chromatograph.

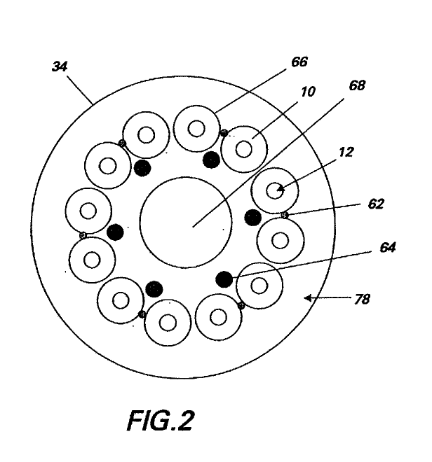

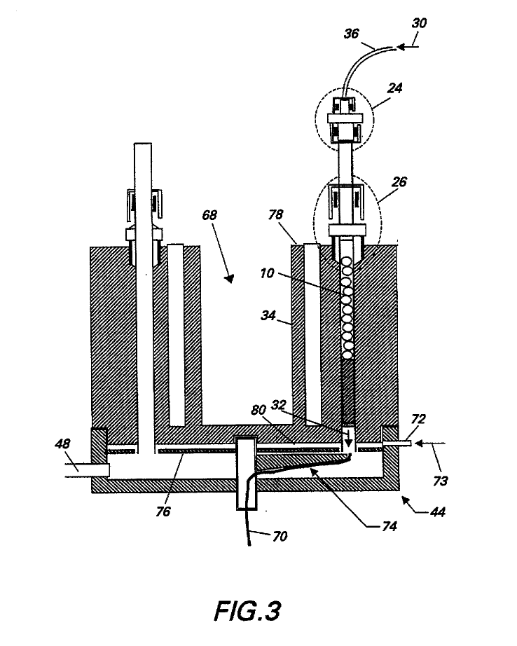

Referring to FIGS. 2 and 3, one embodiment of a thermal block and collection device will now be described. FIG. 2 shows a partial top view of one embodiment of the thermal block and reaction tubes of the present invention. Thermal block 34 can be made of any metal with a sufficiently high melting point to withstand reaction temperatures and sufficient thermal conductivity to efficiently transfer thermal energy into and out of the reaction tube. Preferably, thermal block 34 includes material such as aluminum due to its relatively high thermal conductivity properties. Thermal block 34 is shown as a metal cylinder with holes drilled through the end faces to accept reaction tubes 10. Holes are also drilled to accommodate heater rods 64 and control thermocouples 62. All holes are preferably drilled to have close tolerances to the reaction tubes 10 that will be inserted therein to aid in transferring thermal energy. Additionally, the holes should be able to accommodate some sort of thermal block fitting 26 to form at least one gas-tight seal between thermal block 34 and each reaction tube 10. Thermal block 34 may have a spiral groove machined on the curved exterior surface to permit the addition of cooling coils to facilitate cooling and reactor turn-around time. A blind hole 68 may also be drilled in the center of thermal block 34 to reduce thermal inertia. In one embodiment, a thermal block 34 is about a 5″ diameter block with space for twelve-¼″ diameter reaction tubes. The height of thermal block 34 is determined by the desired length of reactant bed 16.

It should be noted that other layouts, thermal block designs, and different sizes and numbers of reaction tubes may be utilized without varying from the scope of this invention. For example, instead of laying out reaction tubes 10 vertically in parallel and in a circle, they could be laid out in an angled manner so that inlet ports 12 are staggered on thermal block top 78 to provide clearance for thermal block fittings 26 (FIG. 3), while the exit ports 14 (FIG. 3) are all at the same radius on thermal block bottom 80 (FIG. 3) to allow sampling means similar to that shown in FIG. 3. Thermal block 34 could also be rectangularly shaped with an array of reaction tubes 10 arranged in a grid pattern, which would be easy to use with robotics equipment.

One alternative design may include narrow vertical slits cut nearly to the bottom of the cylinder in between pairs of separately heated reaction tubes 10. The slits between the tubes thereby provide an air space between the tubes to permit operation of adjacent pairs of reaction tubes 10 at different temperatures. These slits may then be filled with thermal insulation.

FIG. 3 shows a partial cross-section of the heater block depicted in FIG. 2 and a rotating collection device. For each of the plurality of reaction tubes 10, the reactant gas 30 is delivered to each tube through a delivery line 36 that is sealingly coupled to the tube through an inlet fitting 24 and a thermal block fitting 26. A sampling line 70 of a rotating sampling device 74 collects the reaction products 32 while the reaction products of adjacent reaction tubes are swept out of a vent 48 by a purge gas 73. The purge gas 73 flows between a purge shield 76 and the bottom of the thermal block 34. Reaction tubes 10 are shown taller than thermal block 34 to permit cooling of the exposed portions of reaction tubes 10 to reduce the thermal effects on reactant gas inlet fittings 24.

Purge shield 76 includes a plate having holes corresponding to the arrangement of reaction tubes 10. Purge shield 76 may be attached to the bottom of thermal block 34 at a close spacing, forming a tight seal with collection device 44. Collection device 44 includes, in one embodiment, the rotating sampling device 74 for retrieving reaction products 32. The holes in purge shield 76 permit the ends of reaction rubes 10 to protrude slightly into purge shield 76. Purge gas inlet 72 allows an inert purge gas 73, such as argon or helium, to be introduced into sampling device 74 to sweep the ends of reactor tubes 10 to ensure that there is no sample cross-contamination between neighboring reaction tubes 10. Sampling line 70, which may be heated if desired, transports reaction products 32 to an analytical device 46. Vent 48 allows excess reaction products 32 and purge gas to be released. Vent 48 may be fitted with a pressure regulator to permit operation at pressures above 1 atmosphere. In this embodiment, sampling device 74 selectively rotates from one position to the next so that the selected individual reaction tube 10 is positioned above and adjacent to sampling line 70, allowing samples or reaction products 32 to be taken from each individual reaction tube 10. The rotation of sampling device 74 from one position to the next is determined by the cycle time limits of analytical device 46. Reaction products 32 enter sampling line 70 due to a partial vacuum applied to the end of the sampling line 70 at the analytical device 46, or by operating the sampling device at elevated pressure. Further, the volumetric flow of reaction products 32 flowing through sampling line 70 are preferably kept lower than the volumetric flow of reaction products 32 exiting reaction tubes 10 to avoid drawing in reaction products from adjacent tubes.

Reactant gas inlet fitting 24 is shown here as a Swagelok™ quick disconnect fitting with a metal or polymeric seal such as graphite filled Vespel™, but can be any fitting that is capable of forming a gas-tight seal between reaction tube 10 and reactant gas delivery line 36 (FIG. 1). Reactant gas inlet fitting 24 can also be fashioned from malleable metals such as copper, aluminum or gold, but is preferably an elastomer or inert thermally stable polymer seal that is less time consuming and less tedious to connect and disconnect than Swagelok™ fittings. Elastomer or inert thermally stable polymer seals are also preferred because a permanent fitting such as the Swagelok™ fitting requires large holes to be bored into thermal block 34 to accommodate insertion and removal, and that reduces the heat transfer efficiency of thermal block 34.

Similarly, thermal block fitting 26 forms a gas-tight seal between reaction tube 10 and thermal block 34 to prevent reactant gas 30 and reaction products 32 from passing between reaction tube 10 and thermal block 34 and exiting into the atmosphere. Thermal block fitting 26 preferably forms a gas-tight seal that is stable in the environment of the expected thermal block temperatures and is capable of sealing against elevated pressures.

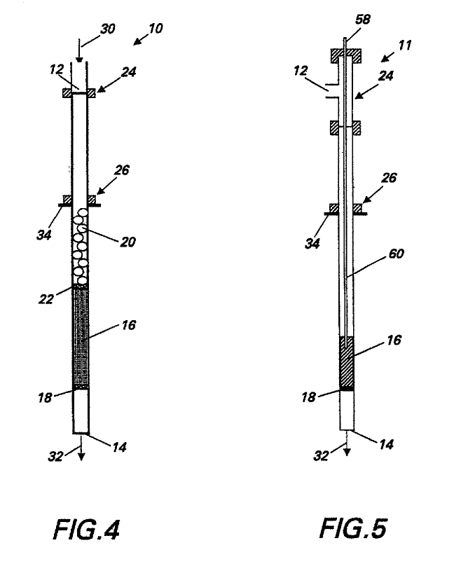

Referring now to FIG. 4, there is shown a side cross-sectional view of one embodiment of the flow-through reaction tube of the present invention. Reaction tube 10 is shown having inlet port 12 where reactant gas 30 enters reaction tube 10, exit port 14 where reaction products 32 exit reaction tube 10, and reactant bed 16 being supported and retained within reaction tube 10 by bed support 18. Optionally, preheat material 20 is shown as being a low surface area, inert structure that allows gas flow, such as beads, rods, cubes, saddles, etc., located near reactant bed 16. An optional bed cap 22 is also shown separating preheat material 20 from reactant bed 16. Two easy-to-disconnect fittings are also shown: reactant gas inlet fitting 24 and thermal block fitting 26.

As mentioned above, reactant bed 16 is a condensed phase material and can be either a catalyst or reagent. Reactant bed 16 could also be a coating on an inert material that is capable of fitting into reaction tube 10, such as an extruded ceramic shape similar to those used to support the catalyst for automobile catalytic converters. More than one reactant bed 16 may be disposed within each reaction tube 10, if desired, and all reactant beds 16 should be disposed within reaction tubes 10 so that they will be disposed within thermal block 34.

Bed support 18 and bed cap 22 can be made of any suitable non-reactive porous metal, glass or ceramic material, and preferably take the form of either a sintered plug or a screen. Bed support 18 may be attached inside of reaction tube 10, for example, by swaging or press-fitting. For example, bed support 18 is preferably a swaged-in porous metal disc or pressed-in compressed metal screen. Other suitable examples of bed support 18 include glass or ceramic fibers or frits.

Preheat material 20 is optional, but is preferably utilized to insure a uniform temperature across the incoming reactant gas 30. Preheat material 20 can be any material suitable to ensure sufficient preheating of reactant gas 30 prior to its coming into contact with reactant bed 16.

FIG. 5 shows another embodiment of the reaction tube of the present invention. Reaction tube 11 may be modified to permit temperature measurement of reactant bed 16 or to permit gaseous co-reactants to be introduced. Here, reaction tube 11 is shown having auxiliary port 58 where center tube 60 is introduced into reaction tube 11. A thermocouple may be inserted into center tube 60 to determine whether certain reactant beds 16 are significantly exothermic or endothermic under particular reaction conditions, or the thermocouple may be used as a temperature control system 42 for controlling the temperature of thermal block 34. Instead of inserting a thermocouple into center tube 60, another temperature measuring device may be inserted, or a gaseous co-reactant may be introduced instead. In this embodiment, reactant gas 30 enters reaction tube 11 via inlet port 12, which may then be located on the side, instead of on the end, of reaction tube 11. The use of auxiliary port 58 and center tube 60 for introducing a gaseous co-reactant would be useful in situations where the mixture of the gaseous co-reactant and reactant gas 30 might produce undesirable reactions. For example, in oxidation reactions, the oxidant could be introduced through the center tube 60 to meet a reactant at reactant bed 16, instead of the gaseous co-reactant and reactant gas 30 meeting before they contact reaction bed 16.

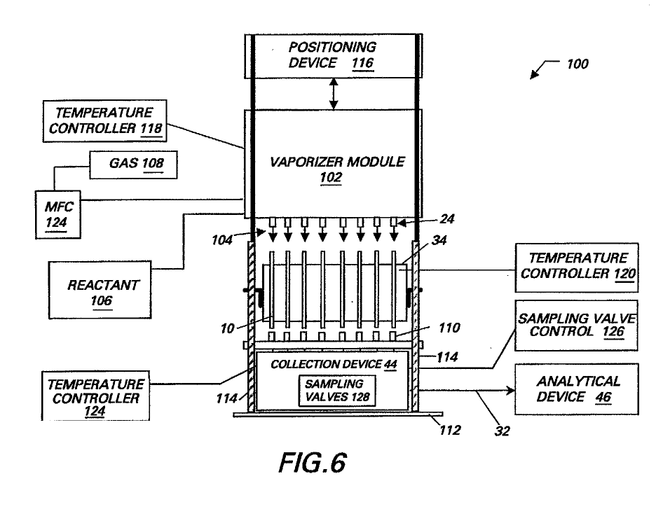

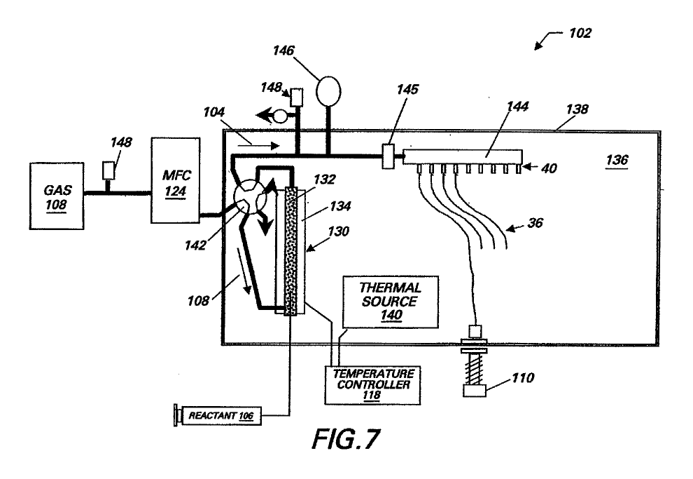

In another embodiment, referring to FIG. 6, a reaction system 100 includes a vaporizer module 102 that simultaneously delivers a reacting vapor 104 to an array of reaction tubes 10, removably positioned within an embodiment of a thermal block 34, to perform a plurality of combinatorial reactions. The vaporizer module 102 preferably dilutes a reactant 106 supplied by a constant flow means, with a diluent gas 108, such as an inert or reactant gas, to form the reacting vapor 104. The flow rate of reacting vapor 104 to each reaction tube 10 is individually-controllable using a flow controller 40 (FIG. 7), however, as discussed above, typically the system is set to provide equal flow to all tubes so as to permit comparisons of catalyst performance. Flow controller 40 may be integrated within vaporizer module 102. The vaporizer module 102 includes an array of entrance probes or inlet fittings 24 each positioned to correspond to the inlet port 12 of a respective one of the array of reaction tubes 10. Similarly, a collection device 44 includes an array of exit probes or exit fittings 110 each positioned to correspond to the exit port 12 of a respective one of the array of reaction tubes 10. The collection device 44 collects and delivers the reaction products 32 to an analytic device 46. The system 100 is mounted on a base 112 having supports 114 such that the components of the system are movable by a positioning device 116 with respect to the supports to allow the reaction tubes 10 to be inserted and removed and to sealingly engage the array of inlet fittings 24 and exit fittings 110 with the array of reaction tubes for performing the reaction.

Additionally, the vaporizer module 102, the thermal block 34, and the collection device 44 are each thermally controlled at one or more predetermined temperatures by respective temperature controllers 118, 120 and 122. Further, a mass flow controller 124 controls the amount of gas 108 that is mixed with the reactant 106. Also, the collection device 44 may optionally include sampling valve control 126 that operates a plurality of sampling valves 128, each associated with a corresponding exit fitting 110, to selectively deliver the reaction products 32 to the analytical device 46.

Referring to FIG. 7, one embodiment of the vaporizer module 102 includes a vaporizer 130 having a mixing bed 132 of packed, inert materials, such as beads, rods, cubes, saddles, etc., and a thermal element 134 for respectively mixing and heating the carrier gas 108 and the reactant 106. Mixing bed 132 allows carrier gas 108 and reactant 106 to flow though the bed at a desired temperature while facilitating the vaporization and sufficient mixing of the two components. The vaporizer 130 may be positioned within a thermally-controlled chamber 136 formed by the walls 138 of the vaporizer module 102. The temperature of the thermal element 134, and hence the mixing bed 132, may be regulated by the temperature controller 118. Similarly, the temperature of the chamber may be regulated by the temperature controller 118, which controls a thermal source 140 such as a heating element.

The vaporizer 130, which is an anular injection device constructed from commercially available tube fittings, packing material and heating element, receives the carrier gas 108 through a valve 142, such as a 6 port purge/run valve, and mixes the gas with the reactant 106 within the heated mixing bed 132 to form the reactor vapor 104. The reactor vapor 104 is then redirected through the valve 140 to a manifold 144 that distributes the reactor vapor 104 through the plurality of flow controllers 40 to the plurality of reactor tubes 10 via delivery lines 36, such as flexible capillary tubes. A filter 145, such as a 15 micron filter, may be positioned upstream of the manifold 144 to restrict the size of any particles that may be in the reactor vapor 104. In the delivery of the reactor vapor 104 to the manifold 144, a pressure sensor 146 and purge valve 148 may be utilized to monitor the reactor vapor and maintain constant head pressure in the manifold. A similar purge valve 148 may also be used in the initial delivery of the gas 108 to the mass flow controller 124. Further, the manifold 144 preferably includes a plurality of flow controllers 40, such as critical orifice flow controllers, for managing the delivery of the reactor vapor 104 to each reactor tube 10.

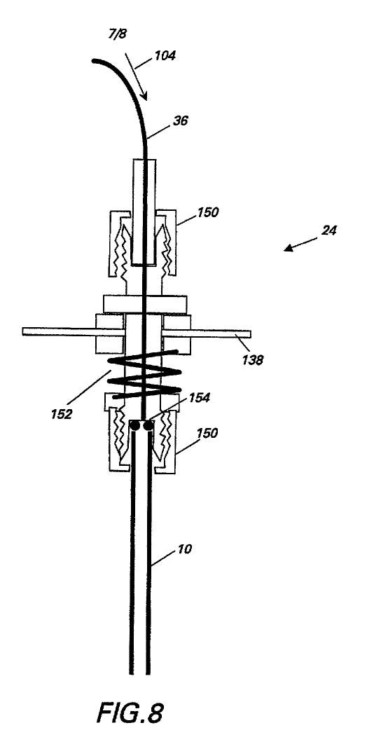

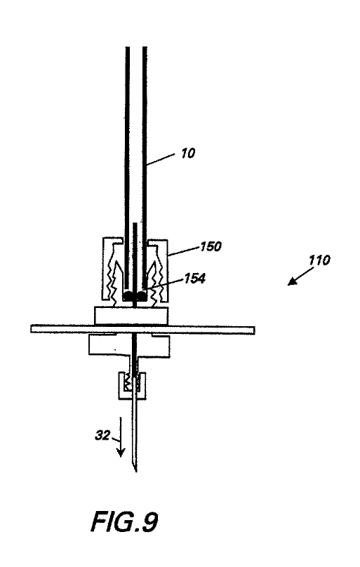

Additionally, the reactor vapor 104 is delivered through the flow controllers 40 and delivery lines 36, which are heated within the chamber 136, to the array of inlet fittings 24. Referring to FIG. 8, each inlet fitting 24 preferably includes quick alignment components 150 to connect each inlet fitting with the delivery line 36 and reaction tube 10. Further, each inlet fitting 24 preferably includes a biasing device 152, such as a spring, and a seal 154, such as an elastomeric o-ring, to allow each reactor tube 10 to be fluidly sealed and to compensate for variations in the height of the reaction tubes 10 within the array while maintaining sufficient sealing force. Referring to FIG. 9, the reaction products 32 resulting from the reaction vapor 104 interacting with the catalyst/reagent in the reactor tube 10 are delivered to the collection device through the exit fitting 110. Like the preferred inlet fitting 24, the preferred exit fitting 110 includes the quick alignment components 150 and the seal 154 to fluidly connect with the reactor tube. For example, the tubes are attached to the exit fitting, but not fixed to the exit fitting, as the tubes may simply rest on the seal. Other inlet fittings and exit fittings may also be utilized, such as ones having needle-shaped ends and intermediately positioned shoulders for supporting an elastomer washer for forming a seal with the reaction tube. Additionally, exit fitting 110 may be attached to a variable length tube that may be utilized to carry the reaction products to a remotely located collection device. In all cases at least one of the inlet and exit fittings must permit the reactor tube diameter to be unchanged at the end. This permits removal of the reactor tubes and also permits close coupling of the reactor tubes to the heating block thus facilitating good temperature control.

In one operational embodiment of the reaction system 100, the positioning device 116 elevates the vaporizer module 102 so that loaded reaction tubes 10 may be inserted into the thermal block 34 and seated against the exit fittings 110. The positioning device 116 then lowers the vaporizer module 102 so that the array of inlet fittings 24 mate with the array of reaction tubes 10, and sealing pressure is applied. The valve 142 is set to allow only the delivery of gas 108 to initiate the gas flow. The thermal block 34 and vaporizer module 102, including the chamber 136 and vaporizer 130, are then heated to the desired reaction temperature and water is purged from the system. Then the collection device 44 is prepared to collect samples of reaction products 32, such as by cooling vials used to collect samples or by initializing the sampling valve control 126. The valve 142 is then set to the position to allow delivery of both the gas 108 and reagent 106 to the vaporizer 130. The reactor vapor 104 is thereby produced and delivered to the array of reaction tubes 10. For example, the gas 108 may be an inert gas such as nitrogen, argon or helium, and the reactant 106 may be dimethylcarbonate (“DMC”) with a boiling point of 90 C. For example, the stream of inert gas 108 may be organically loaded with about 175 mg/min of DMC in about a 265 ml/min gas flow. The stream of reactor vapor 104 is then divided by the manifold 144 and a controlled flow is provided by critical flow orifices that function with a pressure drop of greater than about 15 psi. After running the simultaneous array of reactions for a predetermined reaction time period, and after simultaneously collecting and optionally simultaneously analyzing the reaction products, then the system 100 is shut down. The valve 142 is set to deliver only the gas 108 and the heating of the vaporizer module 102 and thermal block 34 is turned off. The supply of reactant 106 is shut down and the vaporizer module 102 is lifted so that the reaction tubes 10 may be removed and replaced with newly loaded tubes to begin a new reaction.

Example: The following is a working example utilizing the systems and methods described above. This example is to be construed as an illustration of the principles of the invention, and should not be considered limiting the scope of the invention in any manner.

Test reactions were carried out on the reaction of treated silica gel with dimethylcarbonate to form tetramethoxysilane. A test reaction carried out using a ¼″ stainless steel tube fitted with a coarse sintered stainless steel frit and 160 mg of a treated silica reagent at a flow rate of 16 ml/min had a backpressure of 1.6 psig at 340° C. No leakage was detected at the elastomer seals used in this experiment.

A test was run using a single channel reactor. Model reactions were run using 160 mg of silica on a metal screen support in an 8″ long stainless steel tube inserted into a 4″ long furnace at 340° C. The vapor feed consisted of 6 microliters/min of dimethylcarbonate vaporized in helium at 16 ml/min. This was passed through the reaction tube and the effluent collected by passing the exit stream through a 2 ml glass vial at 0° C. The products were analyzed by gas chromatography-mass spectrometry and found to correspond with results found for a similar large scale reaction.

Next, a 32-tube reaction system was tested with a catalyst/reagent set using silica gel with three different levels of a KOH activator treatment. Each reaction tube contained 100 mg±2 mg of silica gel. The reaction was carried out at 320° C. with a helium carrier gas and a mixture of dimethylcarbonate as the reagent with 5% of cyclooctane as an inert internal standard. The products were captured in 32 separate 12×100 mm culture tubes containing 6 ml of o-dichlorobenzene. The helium flow was set to 3 ml/min at room temperature and the dimethylcarbonate flow was 0.19 ml/min or about 6 mg/min per reaction tube. The reaction time was 2 hours. The collected products in solution were analyzed by gas chromatography without further treatment. The results of the analysis were compared to linear calibration curves generated from known materials in similar concentration ranges. The results showed clear differences in yield of the desired product as a function of KOH level in the catalyst.

Finally, a catalyst survey was performed with the plurality of reaction tubes containing different silica sources and/or silica treatments. The simultaneous reaction in the plurality of reaction tubes resulted in a number of standout catalysts that produced high yields. Thus, the system and methods of the present invention may be advantageously utilized for the performance, analysis and discovery of new and unique catalysts, reagents and conditions for reactions.

1. A system for performing simultaneous reactions in a plurality of flow-through reaction tubes, comprising:
a temperature control system operative to maintain a predetermined temperature in each of the plurality of flow-through reaction tubes;
a gas delivery system operative to deliver at a predetermined rate a reaction gas having a uniform composition to each of the plurality of flow-through reaction tubes, wherein the reaction gas is operative to react with a predetermined catalyst disposed within each of the plurality of flow-through reaction tubes to form a reaction product; and
a collection device coupled to at least one of the plurality of flow-through reaction tubes for collecting the reaction product.

2. The system of claim 1, wherein the predetermined temperature of each of the plurality of reaction tubes is substantially the same temperature.

3. The system of claim 1, wherein the predetermined temperature of each of the plurality of reaction tubes is individually controlled.

4. The system of claim 1, wherein the predetermined rate of delivery of reaction gas to each of the plurality of reaction tubes is substantially the same rate.

5. The system of claim 1, wherein the predetermined rate of delivery of reaction gas to each of the plurality of reaction tubes is individually controlled.

6. The system of claim 1, wherein the collection device is simultaneously coupled to each of the plurality of reaction tubes.

7. The system of claim 1, wherein the collection device is coupled to a selected subset of the plurality of reaction tubes.

8. The system of claim 1, further comprising an analytical device connected to the collection device, wherein the collection device is sequentially coupled to a selected one of the plurality of reaction tubes.

9. The system of claim 1, wherein the simultaneous gas reactions comprise a gas-condensed phase reaction.

10. The system of claim 1, wherein the predetermined catalyst associated with each of the plurality of reaction tubes are individually varied to form a combinatorial experiment.

11. The system of claim 1, wherein at least one of the gas delivery system, the temperature control system and the collection device further comprises a plurality of fittings corresponding to each of the plurality of reaction tubes, wherein each of the plurality of fittings is variably biased to operatively sealingly engage the corresponding reaction tube.

12. A chemical reaction and analysis system, comprising:
a set of parallel, flow-through reactors, each reactor having an inlet port and an exit port, each reactor having supports for supporting a condensed phase catalyst or reagent bed disposed within the reactor, and each reactor capable of allowing gas-condensed phase reactions to occur within the reactor;
a reaction gas source fluidly coupled to the reactors;
at least one flow controller operatively connected to the reaction gas source and the reactors to independently regulate the rate of feed of a reactant gas from the reaction gas source to the reactors;
a temperature control system operatively connected to the reactors for controlling a temperature of the reactors; and
a collection device in communication with the exit ends of the reactors for collecting effluent vapor products of the gas-condensed phase reactions and unused reactant gas from the reactors.

13. The system of claim 12, further comprising an analytical system in communication with the collection device for analyzing the effluent vapor products of the gas-condensed phase reactions in real-time.

14. The system of claim 12, wherein the reactors are made of any suitable material to provide an inert environment for the gas-condensed phase reactions that occur within the reactors.

15. The system of claim 12, wherein the temperature control system is a thermal block that substantially surrounds the reactors so that the reactors are substantially in thermal communication with the thermal block.

16. A reaction device for use in gas-condensed phase reaction and analysis systems, comprising:
a reactor tube having an inlet end and an exit end;
at least one bed disposed within the reactor tube; and
a preheating material disposed within the reactor tube for pre-heating a reactant gas before the reactant gas contacts the bed, the preheating material being disposed adjacent to the bed and closer to the inlet end than the bed.

17. The reactor tube of claim 16, wherein the bed is a catalyst bed or a reagent bed.

18. The reactor tube of claim 16, wherein the preheating material comprises an inert, low surface area structure that allows a gas flow.

19. The reactor tube of claim 16, further comprising an auxiliary inlet disposed near the inlet end.

20. The reactor tube of claim 19, wherein the auxiliary inlet allows a reactant gas to be introduced into the reactor tube, and the inlet end is capable of allowing a temperature measuring device to be inserted into the reactor tube for monitoring a temperature within the reactor tube while simultaneously preventing the escape of reaction products and unused reactant gas from the reactor tube.

21. The reactor tube of claim 19, wherein the combination of the auxiliary inlet and the inlet end allows both the reactant gas and a gaseous co-reagent to be introduced into the reactor tube simultaneously.

22. A method for performing simultaneous reactions in a plurality of flow-through reaction tubes, comprising:
maintaining a predetermined temperature in each of the plurality of flow-through reaction tubes;
delivering at a predetermined rate a reaction gas having a uniform composition to each of the plurality of flow-through reaction tubes, where the reaction gas is operative to react with a catalyst disposed within each of the plurality of flow-through reaction tubes to form a reaction product; and
collecting the reaction product.

23. The method of claim 22, where the predetermined temperature of each of the plurality of reaction tubes is substantially the same temperature.

24. The method of claim 22, where the predetermined temperature of each of the plurality of reaction tubes is individually controlled.

25. The method of claim 22, where the predetermined rate of delivery of reaction gas to each of the plurality of reaction tubes is substantially the same rate.

26. The method of claim 22, where the predetermined rate of delivery of reaction gas to each of the plurality of reaction tubes is individually controlled.

27. The method of claim 22, further comprising simultaneously collecting reaction products from each of the plurality of reaction tubes.

28. The method of claim 22, further comprising selectively collecting reaction products from each of the plurality of reaction tubes.

29. The method of claim 22, further comprising cyclically collecting reaction products from each of the plurality of reaction tubes.

30. The method of claim 22, where the simultaneous reactions comprise a gas-condensed phase reaction.

31. The method of claim 22, further comprising movably engaging each of the plurality of reaction tubes such that the reaction gas is operatively sealable within each of the plurality of reaction tubes.

32. The method of claim 22, further comprising movably engaging each of the plurality of reaction tubes such that the reaction gas is operatively sealable within each of the plurality of reaction tubes, where each of the plurality of reaction tubes comprises a variably biased seal.
